(19) United States
(12) Patent Application Publication
(10) Pub. No.: US 2016/0239706 A1
(43) Pub. Date: Aug. 18, 2016

(54) CONVOLUTION MATRIX MULTIPLY WITH CALLBACK FOR DEEP TILING FOR DEEP CONVOLUTIONAL NEURAL NETWORKS

(71) Applicant: QUALCOMM Incorporated, San Diego, CA (US)

(72) Inventors: Daniel Hendricus Franciscus DIJKMAN, Haarlem (NL); Matthew BADIN, Santa Clara, CA (US)

(21) Appl. No.: 14/845,243

(22) Filed: Sep. 3, 2015

Related U.S. Application Data
(60) Provisional application No. 62/116,306, filed on Feb. 13, 2015.
(60) Provisional application No. 62/164,493, filed on May 20, 2015.

(51) Int. Cl. G06K 9/00; G06K 9/66; G06F 17/30

(52) U.S. Cl. CPC G06K 9/00503; G06F 17/3028; G06K 9/66

(57) ABSTRACT

A method of address translation of images and filters to virtual matrices to perform a convolution by matrix multiplication includes receiving an image and a filter. Each image and filter has a memory address. The method also includes mapping the memory addresses to virtual matrix addresses based on a calculated linearized image and a calculated linearized filter. The method further includes converting data in the virtual matrix to a predefined internal format. The method still further includes convolving the image by matrix multiplication of the data in the predefined internal format based on the virtual matrix addresses.

### CROSS-REFERENCE TO RELATED APPLICATIONS

This application claims the benefit under 35 U.S.C. §119(e) to U.S. Provisional Patent Application No. 62/116,306, entitled “CONVOLUTION MATRIX MULTIPLY WITH CALLBACK FOR DEEP TILING FOR DEEP CONVOLUTIONAL NEURAL NETWORKS,” filed on Feb. 13, 2015, and U.S. Provisional Patent Application No. 62/164,493, entitled “CONVOLUTION MATRIX MULTIPLY WITH CALLBACK FOR DEEP TILING FOR DEEP CONVOLUTIONAL NEURAL NETWORKS,” filed on May 20, 2015, the disclosures of which are expressly incorporated by reference herein in their entireties.

### BACKGROUND

1. Field

Certain aspects of the present disclosure generally relate to neural system engineering and, more particularly, to systems and methods for efficient processing of convolution matrix multiply operations.

2. Background

An artificial neural network, which may comprise an interconnected group of artificial neurons (e.g., neuron models), is a computational device or represents a method to be performed by a computational device. Artificial neural networks may have corresponding structure and/or function in biological neural networks.

Convolutional neural networks are a type of feed-forward artificial neural network. Convolutional neural networks may include layers of neurons that may be configured in a tiled receptive field. Convolutional neural networks (CNNs) have numerous applications. In particular, CNNs have broadly been used in the area of pattern recognition and classification.

Deep learning architectures, such as deep belief networks and deep convolutional networks, have increasingly been used in object recognition applications. Like convolutional neural networks, computation in these deep learning architectures may be distributed over a population of processing nodes, which may be configured in one or more computational chains. These multi-layered architectures offer greater flexibility as they may be trained one layer at a time and may be fine-tuned using back propagation.

Other models are also available for object recognition. For example, support vector machines (SVMs) are learning tools that can be applied for classification. Support vector machines include a separating hyperplane (e.g., decision boundary) that categorizes data. The hyperplane is defined by supervised learning. A desired hyperplane increases the margin of the training data. In other words, the hyperplane should have the greatest minimum distance to the training examples.

Although these solutions achieve excellent results on a number of classification benchmarks, their computational complexity can be prohibitively high. Additionally, training of the models may be challenging.

### SUMMARY

In one aspect of the present disclosure, a method of address translation of images and filters to virtual matrices to perform a convolution by matrix multiplication is disclosed. The method includes receiving an image and a filter. Each image and filter has a memory address. The method also includes mapping the memory addresses to virtual matrix addresses based on a calculated linearized image and a calculated linearized filter. The method further includes converting data in the virtual matrix to a predefined internal format. The method still further includes convolving the image by matrix multiplication of the data in the predefined internal format based on the virtual matrix addresses.

Another aspect of the present disclosure is directed to an apparatus including means for receiving an image and a filter. Each image and filter has a memory address. The apparatus also includes means for mapping the memory addresses to virtual matrix addresses based on a calculated linearized image and a calculated linearized filter. The apparatus further includes means for converting data in the virtual matrix to a predefined internal format. The apparatus still further includes means for convolving the image by matrix multiplication of the data in the predefined internal format based on the virtual matrix addresses.

In another aspect of the present disclosure, a computer program product for address translation of images and filters to virtual matrices to perform a convolution by matrix multiplication is disclosed. The computer program product has a non-transitory computer-readable medium with non-transitory program code recorded thereon. The program code is executed by a processor and includes program code to receive an image and a filter. Each image and filter has a memory address. The program code also includes program code to map the memory addresses to virtual matrix addresses based on a calculated linearized image and a calculated linearized filter. The program code further includes program code to convert data in the virtual matrix to a predefined internal format. The program code still further includes program code to convolve the image by matrix multiplication of the data in the predefined internal format based on the virtual matrix addresses.

Another aspect of the present disclosure is directed to an apparatus for address translation of images and filters to virtual matrices to perform a convolution by matrix multiplication, the apparatus having a memory and one or more processors coupled to the memory. The processor(s) is configured to receive an image and a filter. Each image and filter has a memory address. The processor(s) is also configured to map the memory addresses to virtual matrix addresses based on a calculated linearized image and a calculated linearized filter. The processor(s) is further configured to convert data in the virtual matrix to a predefined internal format. The processor(s) is still further configured to convolve the image by matrix multiplication of the data in the predefined internal format based on the virtual matrix addresses.

In one aspect of the present disclosure, a method of processing an input source by a deep convolutional network is disclosed. The method includes processing one portion at a time of the input source by multiple layers of the deep convolutional network to create outputs for each portion. The method also includes aggregating the outputs of each portion into an aggregated output. The method further includes processing the aggregated output by remaining layers.

Another aspect of the present disclosure is directed to an apparatus including means for processing one portion at a time of the input source by multiple layers of the deep convolutional network to create outputs for each portion. The apparatus also includes means for aggregating the outputs of each portion into an aggregated output. The apparatus further includes means for processing the aggregated output by remaining layers.

In another aspect of the present disclosure, a computer program product for processing an input source by a deep convolutional network is disclosed. The computer program product has a non-transitory computer-readable medium with non-transitory program code recorded thereon. The program code is executed by a processor and includes program code to process one portion at a time of the input source by multiple layers of the deep convolutional network to create outputs for each portion. The program code also includes program code to aggregate the outputs of each portion into an aggregated output. The program code further includes program code to process the aggregated output by remaining layers.

Another aspect of the present disclosure is directed to an apparatus for processing an input source by a deep convolutional network, the apparatus having a memory and one or more processors coupled to the memory. The processor(s) is configured to process one portion at a time of the input source by multiple layers of the deep convolutional network to create outputs for each portion. The processor(s) is also configured to aggregate the outputs of each portion into an aggregated output. The processor(s) is further configured to process the aggregated output by remaining layers.

In one aspect of the present disclosure, a method of processing an input source by a deep convolutional network is disclosed. The method includes receiving an image and a filter. Each image and filter has a memory address. The method also includes translating a portion of the image and a portion of the filter to virtual matrices. The method further includes convolving the virtual matrices by matrix multiplication based on a virtual matrix address to generate a convolved image. The method still further includes processing the convolved image by multiple layers of a deep convolutional network to create outputs for each portion.

Another aspect of the present disclosure is directed to an apparatus including means for receiving an image and a filter. Each image and filter has a memory address. The apparatus also includes means for translating a portion of the image and a portion of the filter to virtual matrices. The apparatus further includes means for convolving the virtual matrices by matrix multiplication based on a virtual matrix address to generate a convolved image. The apparatus still further includes means for processing the convolved image by multiple layers of a deep convolutional network to create outputs for each portion.

In another aspect of the present disclosure, a computer program product processes an input source by a deep convolutional network. The computer program product has a non-transitory computer-readable medium with non-transitory program code recorded thereon. The program code is executed by a processor and includes program code to receive an image and a filter. Each image and filter has a memory address. The program code also includes program code to translate a portion of the image and a portion of the filter to virtual matrices. The program code further includes program code to convolve the virtual matrices by matrix multiplication based on a virtual matrix address to generate a convolved image. The program code still further includes program code to process the convolved image by multiple layers of a deep convolutional network to create outputs for each portion.

Another aspect of the present disclosure is directed to an apparatus for processing an input source by a deep convolutional network, the apparatus having a memory and one or more processors coupled to the memory. The processor(s) is configured to receive an image and a filter. Each image and filter has a memory address. The processor(s) is also configured to translate a portion of the image and a portion of the filter to virtual matrices. The processor(s) is further configured to convolve the virtual matrices by matrix multiplication based on a virtual matrix address to generate a convolved image. The processor(s) is still further configured to process the convolved image by multiple layers of a deep convolutional network to create outputs for each portion.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 is a block diagram illustrating an exemplary software architecture that may modularize artificial intelligence (AI) functions in accordance with aspects of the present disclosure.

FIG. 5 is a block diagram illustrating the run-time operation of an AI application on a smartphone in accordance with aspects of the present disclosure.

FIG. 6A illustrates an example of a conventional matrix multiplication.

FIG. 6B illustrates an example of a conventional image and filter linearization.

FIG. 7 illustrates an example of a conventional conversion of matrix elements to an internal memory format.

FIG. 8 illustrates an example of a conventional system for performing matrix multiplication.

FIG. 9 illustrates an example of a conventional system for performing image convolution.

FIGS. 10A and 10B illustrate examples of a system for performing image convolution according to an aspect of the present disclosure.

FIG. 11 illustrates an example of a deep tiling according to an aspect of the present disclosure.

FIGS. 12-15 are flow diagrams illustrating methods in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In conventional systems, filtering may modify or enhance an image. Additionally, a filter may be used to determine if a specific element is present in a portion of an image. For example, the filter may determine if a horizontal line is present in a 3×3 pixel portion of an image. Thus, by applying various types of filters, a system may determine whether specific objects are present in an image. Accordingly, the filtering may be used to classify the image.

Convolution may be specified for linear filtering of an image. Specifically, the convolution output is the weighted sum of input pixels. The matrix of weights may be referred to as the convolution kernel, or filter. The convolution may be obtained by a matrix multiply of a linearized image and a linearized filter.

It is often desirable to rewrite linear algebra problems in terms of matrix multiply because of the improved performance in comparison to other linear algebra primitives. By changing the loop ordering of the naïve convolution implementation, performance may be improved by rewriting the convolution as a dot product that can be transformed into a matrix product.

Naïve implementations introduce an additional step where the raw inputs, such as images and filters, are transformed into matrix inputs. The additional step specifies a double copy so that the matrix inputs are repacked into a predetermined memory structure, such as an opaque internal memory layout that is architecture specific.

Aspects of the present disclosure are directed to removing the aforementioned double copy by creating virtual matrices, as desired, and writing the convolved matrix directly to the internal memory layout. That is, creation of the virtual matrices may bypass the linearization process.

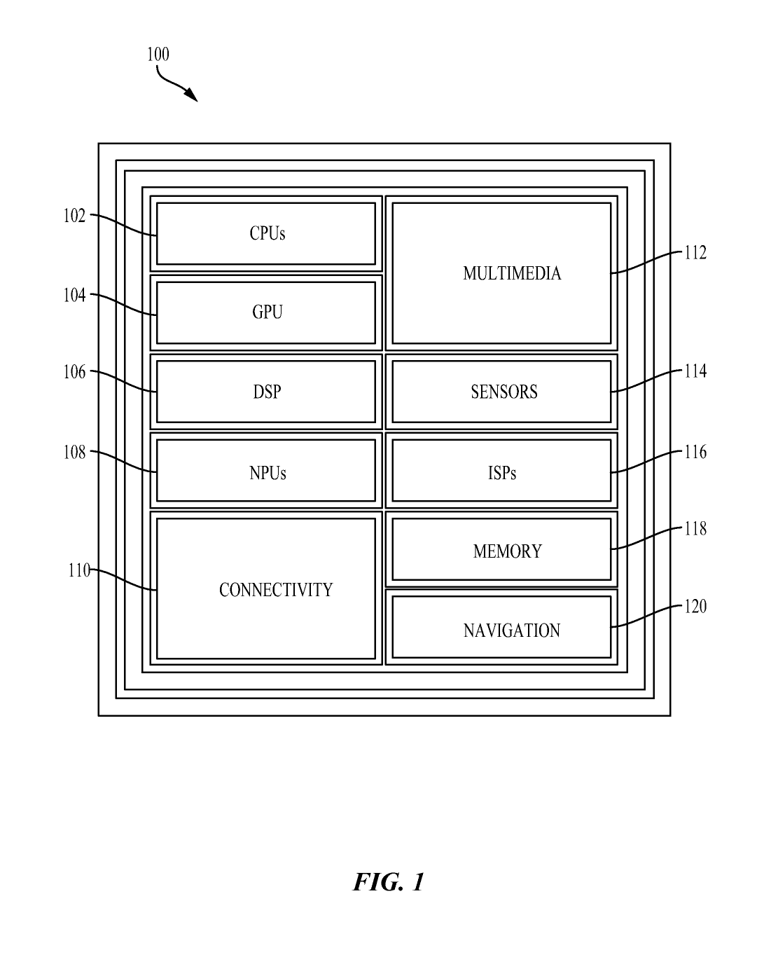

FIG. 1 illustrates an example implementation of the aforementioned creation of virtual matrices using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a Neural Processing Unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs), and/or navigation 120, which may include a global positioning system.

The SOC 100 may be based on an ARM instruction set. In an aspect of the present disclosure, the instructions loaded into the general-purpose processor 102 may comprise code for receiving an image and a filter, each having a memory address. The instructions loaded into the general-purpose processor 102 may also comprise code for mapping the memory addresses to virtual matrix addresses based at least in part on a calculated linearized image and a calculated linearized filter. The instructions loaded into the general-purpose processor 102 may further comprise code for converting data in the virtual matrix to a predefined internal format. The instructions loaded into the general-purpose processor 102 may still further comprise code for convolving the image by matrix multiplication of the data in the predefined internal format based at least in part on the virtual matrix addresses.

In another aspect of the present disclosure, the instructions loaded into the general-purpose processor 102 may comprise code for processing one portion at a time of the input source by multiple layers of the deep convolutional network to create outputs for each portion. The instructions loaded into the general-purpose processor 102 may also comprise code for aggregating the outputs of each portion into an aggregated output. The instructions loaded into the general-purpose processor 102 may further comprise code for processing the aggregated output by multiple remaining layers.

In yet another aspect of the present disclosure, the instructions loaded into the general-purpose processor 102 may comprise code for receiving an image and a filter, each having a memory address. The instructions loaded into the general-purpose processor 102 may also comprise code for translating a portion of the image and a portion of the filter to virtual matrices. The instructions loaded into the general-purpose processor 102 may further comprise code for convolving the virtual matrices by matrix multiplication based at least in part on a virtual matrix address to generate a convolved image. The instructions loaded into the general-purpose processor 102 may still further comprise code for processing the convolved image by multiple layers of a deep convolutional network to create outputs for each portion.

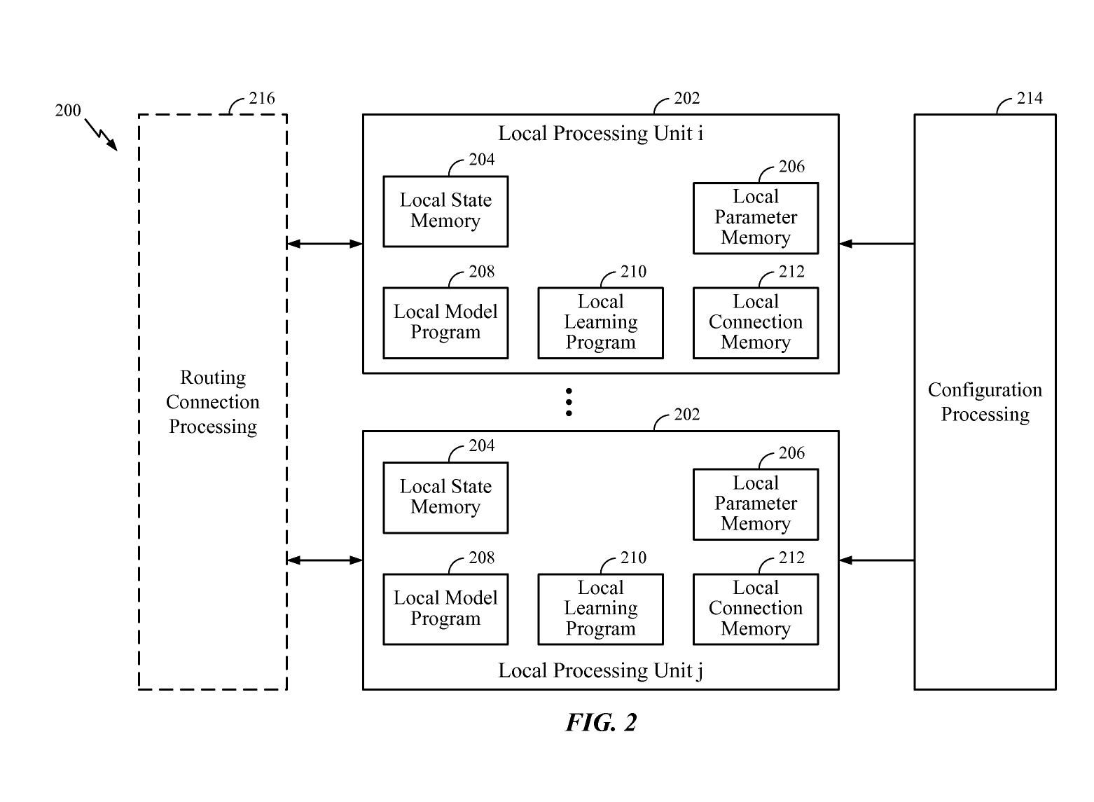

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

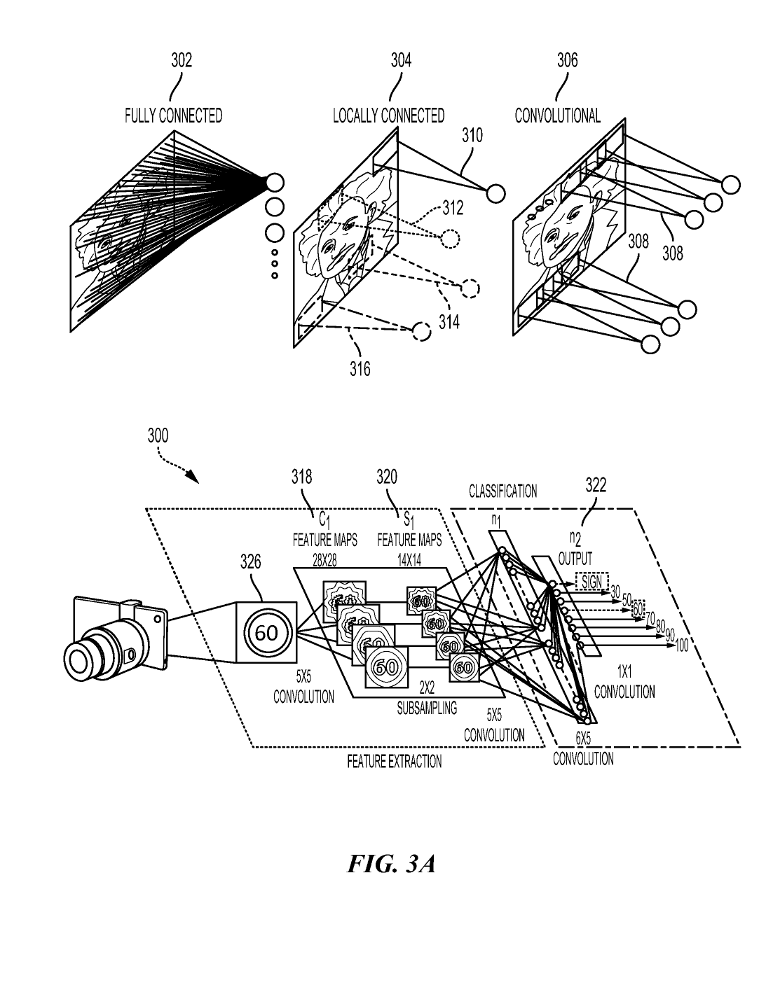

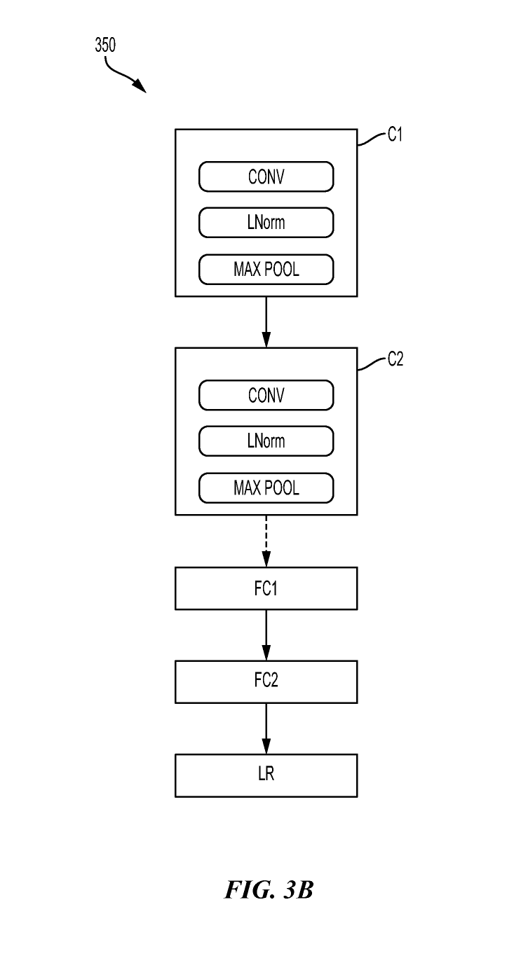

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A DCN may be trained with supervised learning. During training, a DCN may be presented with an image, such as a cropped image of a speed limit sign 326, and a “forward pass” may then be computed to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

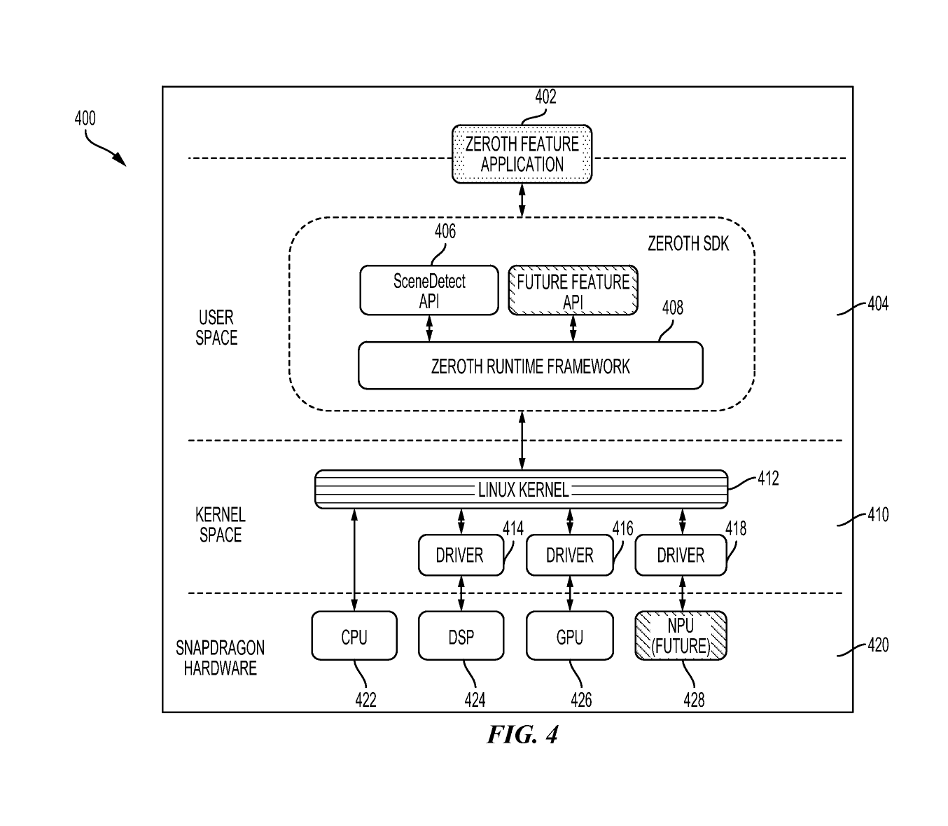

FIG. 4 is a block diagram illustrating an exemplary software architecture 400 that may modularize artificial intelligence (AI) functions. Using the architecture, applications 402 may be designed that may cause various processing blocks of an SOC 420 (for example a CPU 422, a DSP 424, a GPU 426 and/or an NPU 428) to perform supporting computations during run-time operation of the application 402.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in a SceneDetect application programming interface (API) 406 to provide an estimate of the current scene. This request may ultimately rely on the output of a deep neural network configured to provide scene estimates based on video and positioning data, for example.

A run-time engine 408, which may be compiled code of a Runtime Framework, may be further accessible to the AI application 402. The AI application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the deep neural network may be configured to run on a combination of processing blocks, such as a CPU 422 and a GPU 426, or may be run on an NPU 428, if present.

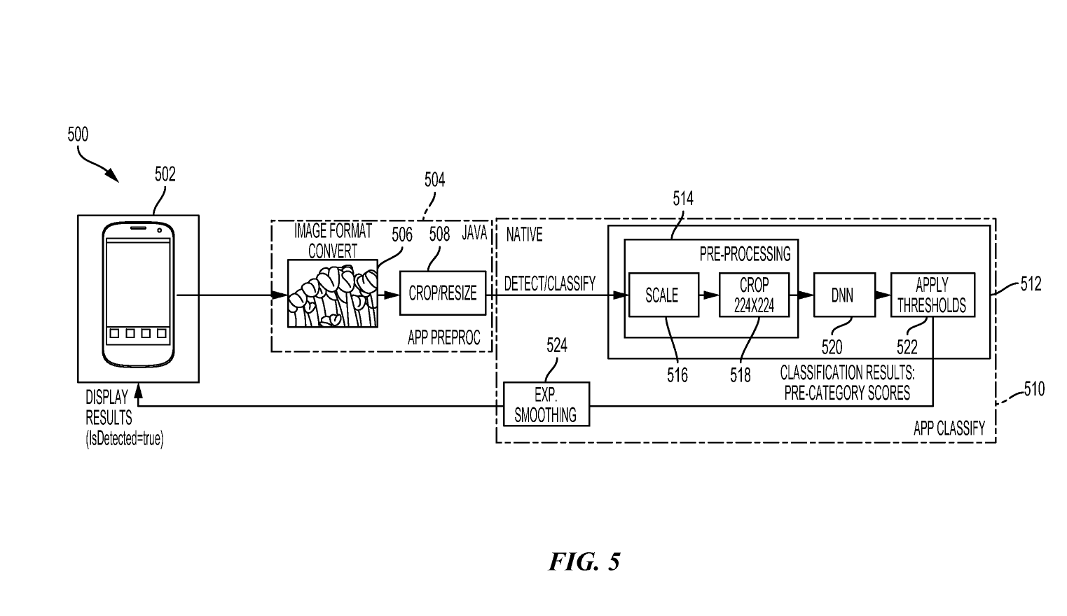

FIG. 5 is a block diagram illustrating the run-time operation 500 of an AI application on a smartphone 502. The AI application may include a pre-process module 504 that may be configured (using for example, the JAVA programming language) to convert the format of an image 506 and then crop and/or resize the image 508. The pre-processed image may then be communicated to a classify application 510 that contains a SceneDetect Backend Engine 512 that may be configured (using for example, the C programming language) to detect and classify scenes based on visual input. The SceneDetect Backend Engine 512 may be configured to further preprocess 514 the image by scaling 516 and cropping 518. For example, the image may be scaled and cropped so that the resulting image is 224 pixels by 224 pixels. These dimensions may map to the input dimensions of a neural network. The neural network may be configured by a deep neural network block 520 to cause various processing blocks of the SOC 100 to further process the image pixels with a deep neural network. The results of the deep neural network may then be thresholded 522 and passed through an exponential smoothing block 524 in the classify application 510. The smoothed results may then cause a change of the settings and/or the display of the smartphone 502.

In one configuration, a machine learning model is configured for address translation of images and filters to virtual matrices to perform a convolution by matrix multiplication. The model includes a receiving means, mapping means, converting means, and/or convolving means. In one aspect, the receiving means, mapping means, converting means, and/or convolving means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

In another configuration, a machine learning model is configured for processing an input source by a deep convolutional network. The model includes a processing means and/or aggregating means. In one aspect, the processing means and/or aggregating means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

In yet another configuration, a machine learning model is configured for processing an input source by a deep convolutional network. The model includes a receiving means, translating means, convolving means, and/or processing means. In one aspect, the receiving means, translating means, convolving means, and/or processing means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

According to certain aspects of the present disclosure, each local processing unit 202 may be configured to determine parameters of the machine learning network based upon desired one or more functional features of the network, and develop the one or more functional features towards the desired functional features as the determined parameters are further adapted, tuned and updated.

### Convolution Matrix Multiply

As previously discussed, aspects of the present disclosure are directed to removing the aforementioned double copy by creating virtual matrices, as desired, and writing the convolved matrix directly to the internal memory layout. That is, creation of the virtual matrices may bypass the linearization process.

It is often desirable to improve the performance of a matrix multiplication for the central processing unit (CPU) and/or for the graphics processing unit (GPU). For example, dependent libraries may be improved by improving the process of a matrix multiplication. Matrix multiplication is desirable in comparison to other primitives because of its increased computational intensity, defined as flops/memory. As an example, a primitive such as axpy (alpha*x+y) performs two flops for each operation (two reads and one write). For two vectors of length n, this becomes (2n)/(3n)=2/3. In contrast, matrix multiply performs (2n³)/(4n²) flops for each operation which is n/2.

In most cases, memory is an order of magnitude slower than computation. Therefore, processes with an increased computational intensity, such as a matrix multiply, are more desirable because the processes with an increased computational intensity extract more work for each unit of memory. Conventional systems measure the efficiency of a matrix multiply based on the amount of time used to produce a result as compared to performing another task, such as fetching inputs or writing the output.

In conventional systems, an image and a filter are not recognizable inputs to matrix multiply primitives. Thus, to be recognizable by the matrix multiply primitives, the image and filter are converted to matrix inputs by duplicating portions of the image. The duplication reduces performance because of the extra memory usage. Specifically, an additional copy is specified for the matrix multiply implementation as the memory is repacked (based upon the size of the L1 and L2 cache memory and the register blocking of the inner most matrix multiply kernel) into an architecture specific layout for sequential memory access inside the inner most matrix multiply kernel.

The repacking may be used for both blocking of memory (for caches) and streaming of memory (from cache to registers). It should be noted that the repacking is specified in conventional systems for matrix multiply implementations with deep memory hierarchies, such as CPUs. In contrast to CPUs, conventional GPUs do not reorder the memory. Rather, a GPU may tile over the result matrix to divide the work among processing units and then block on the input matrices into small enough blocks to fit in cache. That is, GPUs do not change the layout of the memory that is cached. Furthermore, conventional GPUs block on two dimensions (M and N, see FIG. 5) whereas CPUs block on three dimensions.

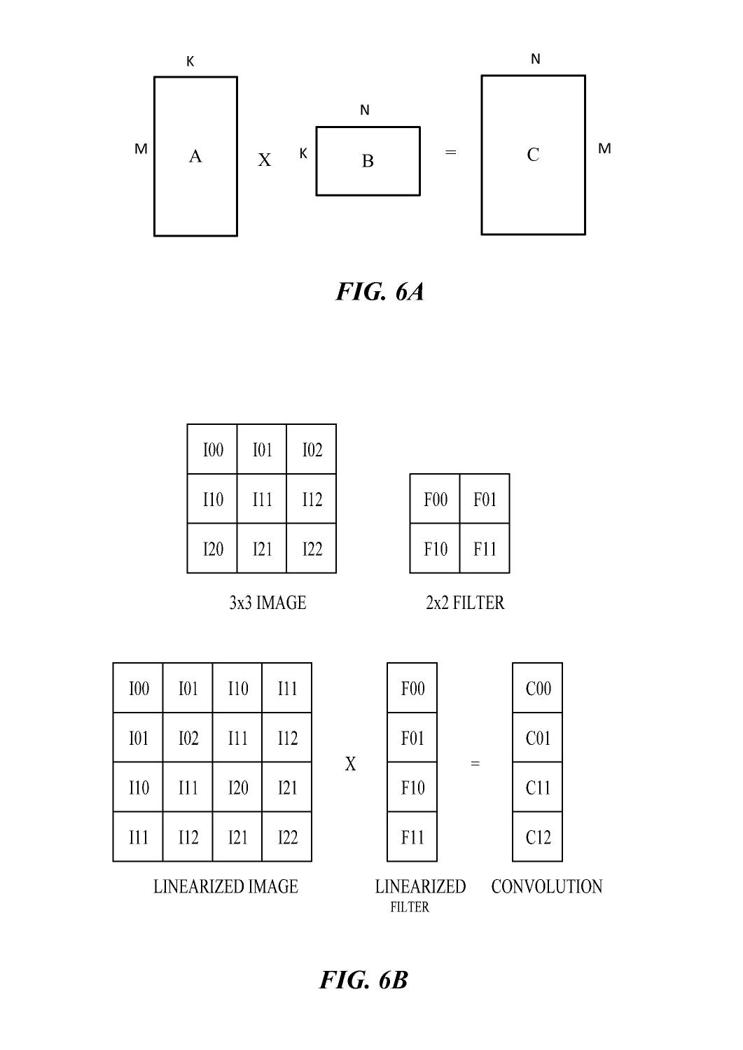

FIG. 6A illustrates an example of a matrix multiplication of two matrices, matrix A with a dimension of M×K and matrix B with a dimension K×N. The product of a matrix multiplication is matrix C with dimensions M×N.

Aspects of the present disclosure are directed to performing a matrix multiply without the aforementioned double copy. In one configuration, a matrix multiply primitive is specified to recognize images and not matrices.

Specifically, according to aspects of the present disclosure, an improved matrix multiply primitive uses conventional convolution arguments, such as image, filters, stride, padding, number of filters, and/or the dimensions of the input and output. Furthermore, the improved matrix multiply primitive computes a convolution reusing the inner matrix multiply kernel that is used in the conventional matrix multiply primitive. Thus, the improved matrix multiply primitive may avoid the double copy by skipping the linearization step. That is, the linearization step may be skipped because the raw image and filter inputs are used and repacked to the internal memory layout specified by the inner matrix multiply kernel.

FIG. 6B illustrates linearization of an image and filter for a conventional matrix multiplication. As shown in FIG. 6B, portions of a 3×3 image are duplicated into a linearized matrix, where each row of the linearized image represents a single location where the 2×2 filter would be applied. The 3×3 image may be a portion of a larger image. The filter is also linearized to be described as a dot product.

As shown in FIG. 6B, the 2×2 filter would be applied, four pixels at a time, to the image. Beginning with the top left portion of the image, the filter would be applied to pixel I00, I01, I10, I11. Therefore, the first row of the linearized image is I00, I01, I10, I11. Moving in a left to right manner, the next four pixels for the filter are I01, I02, I11, and I12. Thus, the second row of the linearized image is I01, I02, I11, and I12. The contents of the matrix, such as I00, I01, etc. . . . correspond to address locations.

Additionally, as shown in FIG. 6B, the filter is also linearized so that a convolution is derived by applying the linearized filter to the linearized image. For example, C00 is the result of ((I00×F00)+(I01×F01)+(I10×F10)+(I11×F11)). That is, when a filter is applied to a single location on the image, it produces several partial dot products that then are summed. The number of dot products is equal to the area of the filter. For example, the 2×2 filter of FIG. 6B produces four partial dot products. In another example, a 3×3 filter produces nine partial dot products. The length of any individual dot product is equal to the product of the number of channels in the image and the area of the filter. The number of channels increases or decreases based upon the number of filters applied to an image at proceeding stages.

Focusing on a single stage, to obtain one complete dot product, each individual pixel inside the filter (for all channels) is combined into a single vector. If the dot products are produced in parallel, such that each dot product is a filter applied to a single location, the result is a matrix multiply. Still, when the total length of the aforementioned vectors is larger than the blocking size for K, only a portion of the vector may be stored and calculated for a specific iteration. Therefore, the remaining calculations are computed after the inner most loop has completed. It should be noted that the values K and M referenced in the disclosure are based on examples of the values of K and M from FIG. 6A. For example, K is the size of the length of Matrix A and width of Matrix B.

Thus, for each iteration of the outer loop of the matrix multiply implementation, the repacking routine first calculates the current position in the linearized image based upon the current value of k. It is assumed that k is a multiple of the blocking size on K. Accordingly, an increased amount of memory is specified to copy the image matrix and filter matrix to a linearized image matrix and linearized filter matrix. Thus, both the copy and the temporary space may be bypassed by removing the linearization step. The linearized image matrix may be referred to as a linearized image and the linearized filter matrix may be referred to as the linearized filter.

In conventional systems, the internal memory layout is specified to enable the currently operated memory to fit inside the cache and to improve streaming (i.e., prefetching) for the next piece of memory. Moreover, sequential access is used for improved prefetching.

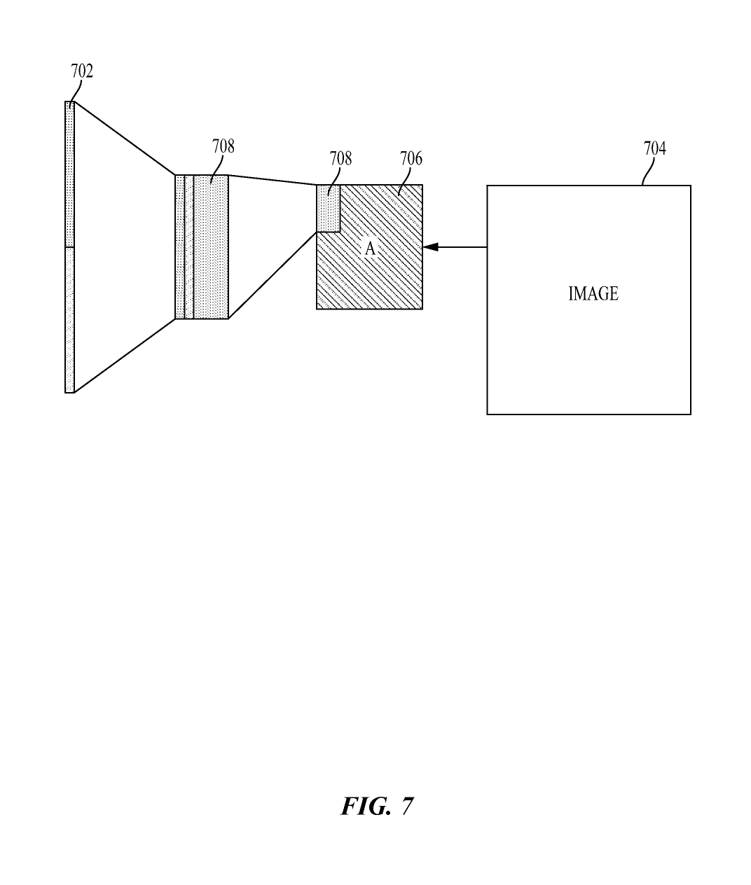

FIG. 7 illustrates an example of a predetermined internal memory format 702. In the conventional system, the image 704 is linearized to a matrix 706. As discussed below, during the matrix multiply, a driver (not shown in FIG. 7) may request a portion (e.g., block 708) of the matrix 706 from a packer (not shown in FIG. 7). The packer converts the block 708 of the matrix 706 to an internal memory format 702.

In most cases, because a size of a CPU cache is limited, only a block of the matrix A may be referenced at any given time. The size of the block may be based upon the blocking size for M and the blocking size for K, which are based on the size of the caches for a given CPU. The aforementioned block may be repacked to an internal format. The internal format may have a width equal to the register blocking size of the inner most kernel and a length based on the blocking size for K. This block of the matrix will be sequentially packed into the internal format by a packing routine. It should be noted that neither K nor M exist with an image, let alone the matrix. However, the internal matrix multiply kernel specifies the blocking sizes, in the internal format, for improved performance. Thus, the image and filter should be converted via a packing routine that receives an input of an image and an input of a filter and outputs the internal memory layout.

It should be noted that in FIG. 7 the block 708 of matrix 706 is not a separate matrix. Rather, the block 708 is a visualization of a portion of matrix 706 that may be requested from a driver during a matrix multiply.

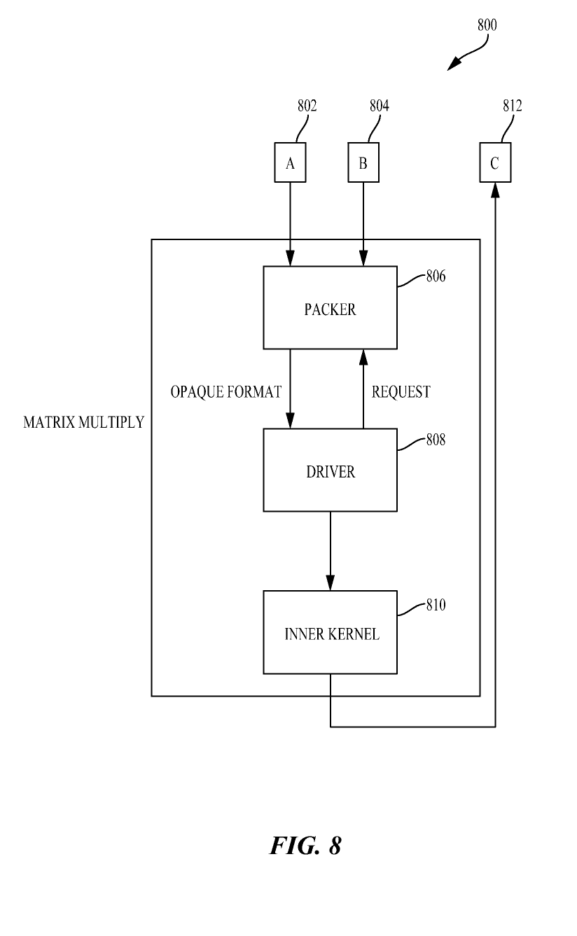

FIG. 8 illustrates an example of a conventional matrix multiply 800 for multiplying matrices A 802 and B 804 to output a product matrix C 812. As shown in FIG. 8, a first matrix A 802 and a second matrix B 804 are input to a packer 806. The packer 806 handles requests from the driver 808 for specific portions of matrix A 802 and matrix B 804 to generate a portion of matrix C 812 via matrix multiplication. In response to the request, the packer 806 converts the requested portions of matrix A 802 and matrix B 804 to the internal format. As previously discussed, a conventional system writes the portions of matrix A 802 and matrix B 804 to the internal format to improve performance. The internal format is transmitted to the driver 808, which in turn transmits the converted portions of matrix A 802 and matrix B 804 to the inner matrix multiply kernel 810. The inner matrix multiply kernel may be referred to as the inner kernel. The inner kernel 810 receives the converted portions of matrix A 802 and matrix B 804 in the internal format and the inner kernel 810 writes the converted portions to the portion of matrix C 812. The matrix multiplication may be repeated until all portions of matrix C 812 are determined.

It should be noted that the internal format may be referred to as an opaque format. Furthermore, the internal format may be specified by the system according to the system specifications such that the internal format may also be referred to as a predefined internal format.

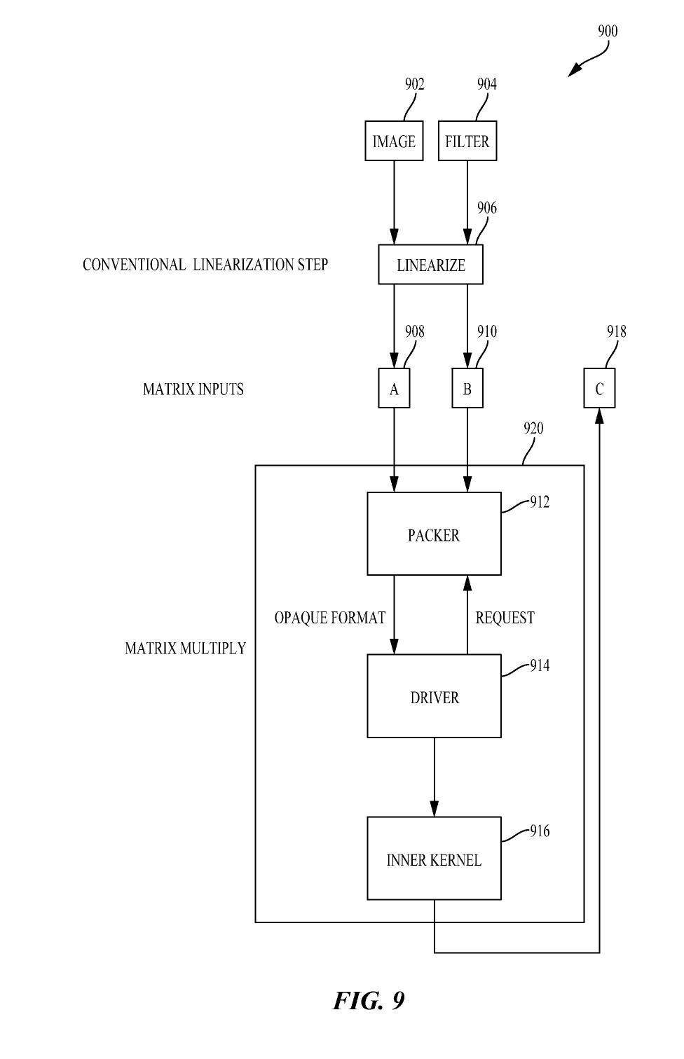

FIG. 9 illustrates another example of a conventional system 900 for a convolution. As previously discussed, matrix multiplication may not interpret a standard image and filter. Therefore, the image and filter are linearized prior to the matrix multiplication. That is, as shown in FIG. 9, the image 902 and filter 904 are input to a linearizer 906 to be linearized (i.e., converted) to matrix A 908 and matrix B 910. The matrix A 908 and matrix B 910 are multiplied according to the conventional matrix multiply described in relation to FIG. 8. Specifically, similar to the example of FIG. 8, the matrix multiply block 920 of FIG. 9 includes a packer 912, a driver 914, and an inner kernel 916. The output of the matrix multiply block 920 is a portion of the matrix C 918,

As shown in FIG. 9, the conventional convolution system includes a double copy. The first copy is specified to convert the image 902 and filter 904 to the respective matrices 908 and 910. The second copy is specified to convert the matrices, such as matrix A 908 and matrix B 910, to the internal format. As previously discussed, the double copy may reduce system performance.

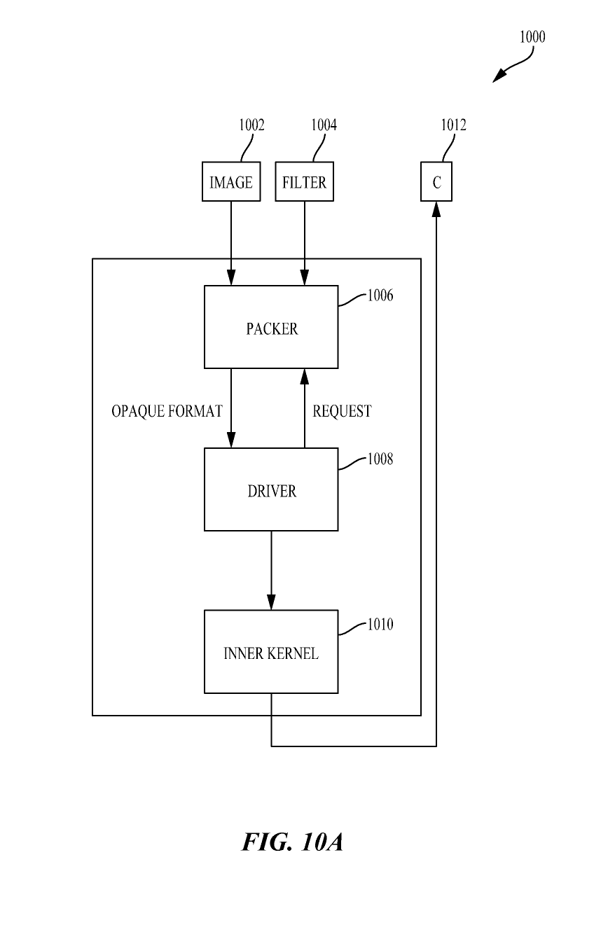

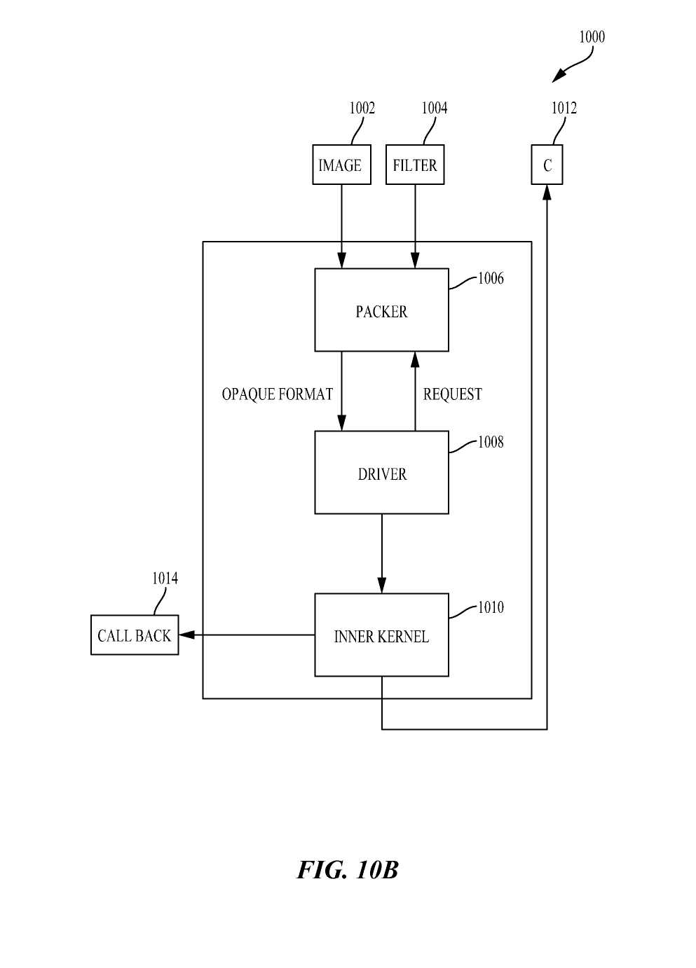

FIG. 10A illustrates an example of a convolution 1000 according to an aspect of the present disclosure. As shown in FIG. 10A, a double copy is not performed because the packer is configured to read images. That is, as shown in FIG. 10A, an image 1002 and filter 1004 are input to the packer 1006. Specifically, in this configuration, the driver 1008 requests a portion of matrix A and a portion of matrix B from the packer. Moreover, the packer 1006 interprets the request and determines the portions of linearized matrices that correspond to the requested portions of matrices A and B. Still, because the image 1002 and the filter 1004 have not been linearized to matrices A and B, the packer 1006 generates virtual matrices A and B (not shown in FIG. 10A) based on the image 1002 and the filter 1004. Furthermore, the packer 1006 writes the data located at the addresses of the virtual matrices to the internal format, which is passed to the driver 1008. Furthermore, the driver 1008 transmits the internal format that is generated from the virtual matrices, to the inner kernel 1010. The inner kernel 1010 receives the internal format and the inner kernel 1010 writes the converted portions generated from the virtual matrices to the portion of matrix C 1012.

As an example, the driver may request the left half (i.e., left two columns) of a linearized image (as shown in FIG. 6B). The packer of the present configuration associates positions of the linearized image with the pixels of the actual image. For example, in the linearized image, the first two elements of the first column (i.e., I00 and I01) are associated with the first two elements in the row of the image (i.e., I00 and I01). Thus, the packer performs an address translation to find a correct portion of an image that is associated with the portion of a matrix requested by the driver. Based on the address translation, the packer writes the portion of the image to the internal format, thereby bypassing the step of writing the image to a matrix and then writing the matrix to the internal format.

More specifically, each image and filter, such as the image 1002 and filter 1004 of FIG. 10A, has a memory address. In one configuration, the packer maps the memory addresses to virtual matrix addresses. The mapping is based on a calculated linearized image and a calculated linearized filter for a portion of a matrix requested by the driver. Furthermore, the packer converts the virtual matrix addresses to the internal format. That is, after writing the virtual matrices generated from the image and filter to the internal format, the packer transmits the internal format to the driver. Finally, the image and the filter are convolved by matrix multiplication of data in the internal format based on the virtual matrix addresses. Specifically, the matrix multiplication may be similar to the matrix multiply described in relation to FIG. 8.

FIG. 10B illustrates an example of a convolution 1000 according to an aspect of the present disclosure. As shown in FIG. 10B, the inner kernel 1010 may output a product of the matrix multiply to a call back block 1014. The call back block 1014 may use the convolution and/or product of the matrix multiply for further processing, such as deep tiling. That is, processing, such as deep tiling may be performed without having to wait for all of matrix C 1012 to be written and may be performed on a portion of matrix C 1012. It should be noted that the driver 1008 may instruct the inner kernel 1010 to output the data to the call back block 1014.

### Deep Tiling

As previously discussed, deep convolutional neural networks (DNNs) and/or deep convolutional networks (DCNs) are specified to classify data. Typically, the data is image data and the deep convolutional neural network determines the objects that are present in an image. Still, the data may be audio data or other data that is subject to classification or regression. In the present application, the deep convolutional neural network may refer to a deep convolutional network. Regression may apply when the output is real numbers, such as the estimate of the corners of bounding boxes around objects in images.

Aspects of the present disclosure are directed to improving the run-time performance, memory usage and power usage of deep convolutional neural networks by tiling across multiple layers of the deep convolutional neural network. Additionally, aspects of the present disclosure are described from a CPU viewpoint assuming a specific amount, such as 1 MB, of L2 cache. Still, aspects of the present disclosure may be applied to a custom hardware implementation, such as an application-specific integrated circuit (ASIC) with 1 MB of local SRAM memory available, or any other configuration.

Deep convolutional neural networks may include multiple layers. Each layer may apply a transformation to the data. Furthermore, the output of each layer is used as input for the next layer. Additionally, or alternatively, the layers may form a directed acyclic graph. The data is transformed from the input layer to the final output layer. The output layer may be referred to as a softmax layer. Specifically, the output layer outputs probabilities of what is visible in the image (such as, a tree, a car, or a person). The deep convolutional neural network is trained to perform the classification task by setting the weights of the network using stochastic gradient descent. The deep convolutional neural network may have one or more outputs. Furthermore, the deep convolutional neural network may be trained for regression problems such as estimating bounding boxes around objects in the input data.

As an example of a deep convolutional neural network, the architecture and properties of the deep convolutional neural network used by a detection application are provided in TABLE 1. Specifically, TABLE 1 provides the layer name, window matrix size, weight size, output file size, and execution time.

TABLE 1

| Layer | Window Matrix | Weights | Output File | Execution |
|---|---|---|---|---|
| Name | Size | Size | Size | Time |
| Input | — | — | 600K | — |
| Conv1 | 7 × 7 | 56K | 4800K | 25 ms |
| Act1 | 1 × 1 | — | 4800K | 2.5 ms |
| Norm1 | 1 × 1 | — | 4800K | 5 ms |
| Pool1 | 3 × 3 | — | 1200K | 4 ms |
| Conv2 | 5 × 5 | 1500K | 800K | 24 ms |
| Act2 | 1 × 1 | — | 800K | 0.1 ms |
| Norm2 | 1 × 1 | — | 800K | 0.6 ms |
| Pool2 | 3 × 3 | — | 200K | 0.1 ms |
| Conv3 | 3 × 3 | 1100K | 150K | 4.5 ms |
| Act3 | 1 × 1 | — | 150K | 0.1 ms |
| Conv4 | 3 × 3 | 1300K | 150K | 5.2 ms |
| Act4 | 1 × 1 | — | 150K | 0.1 ms |
| Conv5 | 3 × 3 | 1100K | 150K | 4.7 ms |
| Act5 | 1 × 1 | — | 150K | 0.1 ms |
| Pool5 | 3 × 3 | — | 31K | 0.1 ms |
| FullyCon6 | — | 64000K | 4K | 25 ms |
| Act6 | — | — | 4K | 0 ms |
| Dropout6 | — | — | 4K | 0 ms |
| FullyCon7 | — | 17000K | 4K | 7 ms |
| Act7 | — | — | 4K | 0 ms |
| Dropout7 | — | — | 4K | 0 ms |
| FullyCon8 | — | 8200K | 1K | 0.3 ms |
| Output | — | — | 1K | 0 ms |

The image processing of each layer is known to those of skill in the art. The layers may include an activation layer (Act), a normalization layer (Norm), a convolution layer (Cony), a pooling layer (Pool), a dropout layer (Dropout), and a fully connected layer (FullyCon). Aspects of the present disclosure are not concerned with the function performed at each layer. Still, it should be noted that each layer operates on a local window of the output of the preceding layer.

In TABLE 1, the windows have a size between 1×1 and 7×7 pixels, as listed in the Window Matrix Size column of the table. It should be noted that the original image may have a size that is greater than the window size. For example, the input image may have a size of 200×200 pixels and may include three channels, such as red, green, and blue. In the present configuration, the data from an n by n window of the preceding layer is used to produce the output of a current layer.

As shown in TABLE 1, after an input image is received, a first convolution (Conv1) is performed on the image. A window size of 7×7 may be used for the first convolution. The first convolution may determine, based on the use of a filter, whether certain patterns or edges are present in an image. For an image size of 200×200 pixels, the first convolution may be performed approximately ninety-six times. That is, the 7×7 window may be applied to ninety-six different locations of the image. Additionally, as shown in TABLE 1, the output size of the first convolution is approximately 4800K, which may be larger than a size of a conventional cache.

After performing the first convolution, a first activation (Act1) may be performed. The activation sets a value of pixels that are less than zero to zero. The output of the activation may also be approximately 4800K. Furthermore, a first normalization may be performed after the first activation. The normalization layer may be used to normalize the output of the convolution filters. For example, the normalization layer may provide whitening or lateral inhibition

After the first normalization, a first pooling (Pool1) is performed. The pooling reduces the size of the image by reducing the maximum pixel value of the pixels in a window, such as the 3×3 window. The pooling reduces the output to approximately 1200K.

As shown in TABLE 1, the convoluting, activating, and pooling, may be repeated for a number of tables before a fully connected layer (FullyCon) is processed. The fully connected layer performs a matrix multiply, using the full output of Pool5 to produce an output. The dropout layer randomly sets output values of the fully connected layer to zero with a specified probability (such as 50%). The dropout layer may prevent co-adaptation of features that the fully connected layer produces. The final layer is an output layer. The output layer provides a determination of the one or more objects present in the image based on the inputs of the previous layers.

It should be noted that the weights of the convolution layers and fully connected layers may be determined via backpropagation. Backpropagation is a process for training a deep neural network based on known image labels.

The size of the input to each layer (i.e., the sum of the weights and the output of the preceding layer) affects the system performance. TABLE 1 lists the output sizes of each layer, assuming that all values are stored using the 32 bit floating point format. Still, aspects of the present disclosure are also contemplated for using 16 bit signed integers or any other integer amount.

Note that the sum of the size of the inputs and outputs of the layers Conv1 through Conv2 are larger than the size of a conventional L2 cache of a CPU (e.g., 1 MB). Thus, in the conventional system, for each layer, the CPU reads the entire input from main memory and writes the output back to main memory.

The aforementioned cache performance affects performance as shown in the timing of layers Act1 and Act2 (TABLE 1). The activation layers perform an operation on their data, such as output=max(0, input). Based on the example of TABLE 1, Layer Act2 uses 0.1 ms to process 800K of data (note that 800K fits in the L2 cache). Furthermore, based on the example of TABLE 1, the first activation layer processes six times as much data (4800K, this does not fit in the L2 cache). Still, the amount of time to process the data at the activation layer is not six times the amount of work (6×0.1 ms=0.6 ms). Rather, the average time is 2.5 ms. That is, approximately 2 ms are for reading from and writing to main memory.

Tiling is used in conventional systems to improve performance. The data is processed one tile (2D block of data) at a time. It is desirable for the size of tiles to be small enough so that the data fits in (L1, L2) cache.

Current deep convolutional neural network implementations use tiling at the per-layer level. For example, some layers use matrix multiplications and are implicitly tiled. Aspects of the present disclosure are directed to tiling across layers, which may be referred to as deep tiling.

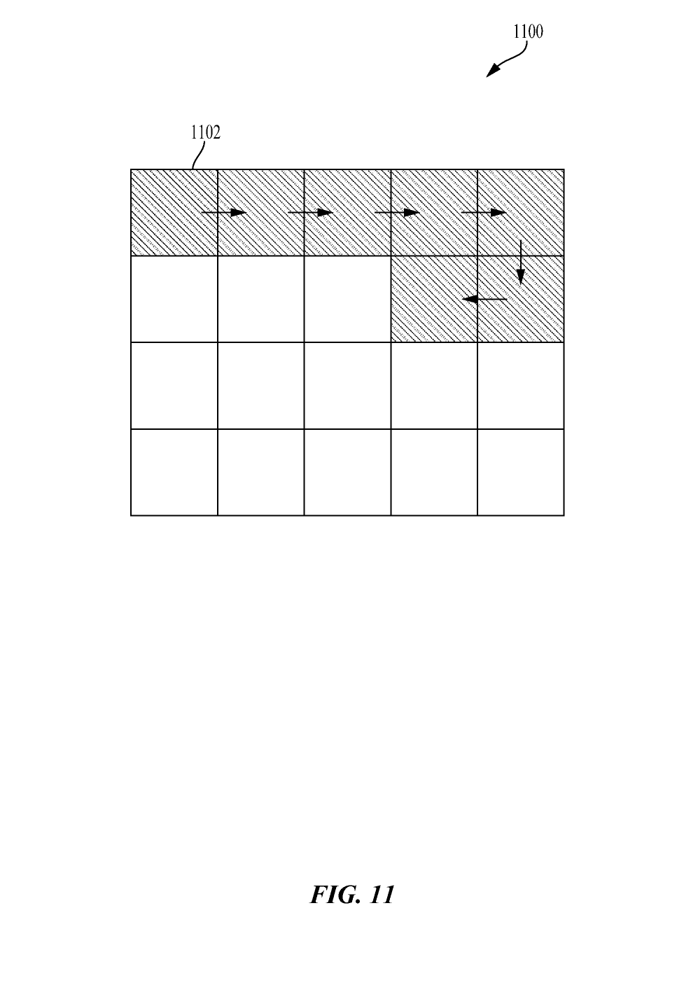

In one configuration, as shown in FIG. 11, tiles 1102 are processed for an input image 1100. Each tile may be processed through a specified number of input layers (see TABLE 1) until a tile layer is declared valid. The size of the tile may vary at each layer due to the local window size. Furthermore, in one configuration, all pixels in the preceding layers that are part of the window should be declared valid. That is, a tile may be declared valid when the processing of the pixels for the specified layers is complete. For example, each tile may be processed from the input layer to the first pooling layer (POOL1). In this example, the tile may be declared valid when the processing of the pixels for the first pooling layer is complete. The processing of the specified number of layers may be performed in the cache, such as the L1 and/or L2 cache. Accordingly, after the layers of each tile have been processed, the entire image may be processed for any remaining layers.

As previously discussed, in one example, each tile may be separately processed from the input layer to the first pooling layer. Additionally, after processing each tile from the input layer to the first pooling layer, the entire image may be processed from the second convolution layer (CONV2) to the output layer. Of course, aspects of the present disclosure are not limited to processing each tile from the input layer to the first pooling layer as the tiling may proceed to process additional layers if desired.

Moreover, the declaration of a valid tile may be performed one tile at a time in a specific pattern, such as, for example, working from top to bottom in a zig-zag order (FIG. 11). The order may be arbitrary and may vary based on the desired output. That is, aspects of the present disclosure are not limited to the zig-zag order. The valid area is propagated from layer to layer by computing the outputs for which the inputs are valid. This leads to an L-shaped area that is valid in any layer at any time.

By tiling across multiple layers, all computations for layers, such as Conv1 through Pool1, may be performed from the cache when possible. The processing may be performed by different cores. The weights for Conv2 are too large to fit in a 1 MB cache currently, but switching to a different representation, such as a 16 bit representation may mitigate the size discrepancy. It should be noted that the aforementioned address translation of images and filters to virtual matrices to perform a convolution by matrix multiplication may be specified to generate the output of each convolution layer.

The deep tiling process may be performed based on the following pseudo code:

while not all tiles valid:

declare new tile valid in input layer

for layer in tiling_layers:
get valid area (L-shape) from preceding layer
compute what area U can be updated for this layer (this will generally be a rectangle)
compute output for area U
set new valid area L shape for layer

The aforementioned pseudo-code is a summary of the deep tiling. Specifically, after a tile has been declared valid, the pseudo-code enters a loop to determine a value area from a preceding layer, computing an area that may be updated for the present layer, determining an output for the present layer, and setting the present layer as valid. It should be noted that the pseudo-code is an example of the deep tiling. The concepts of the present disclosure are not limited to the pseudo-code.

In one configuration, new functionality is specified for each layer. Specifically, each layer should be able to tell what new area it can make valid given the currently and previously valid input areas. Additionally, each layer should apply its operation to a limited area.

It should be noted that the call back of FIG. 10B may be used for the aforementioned deep tiling.

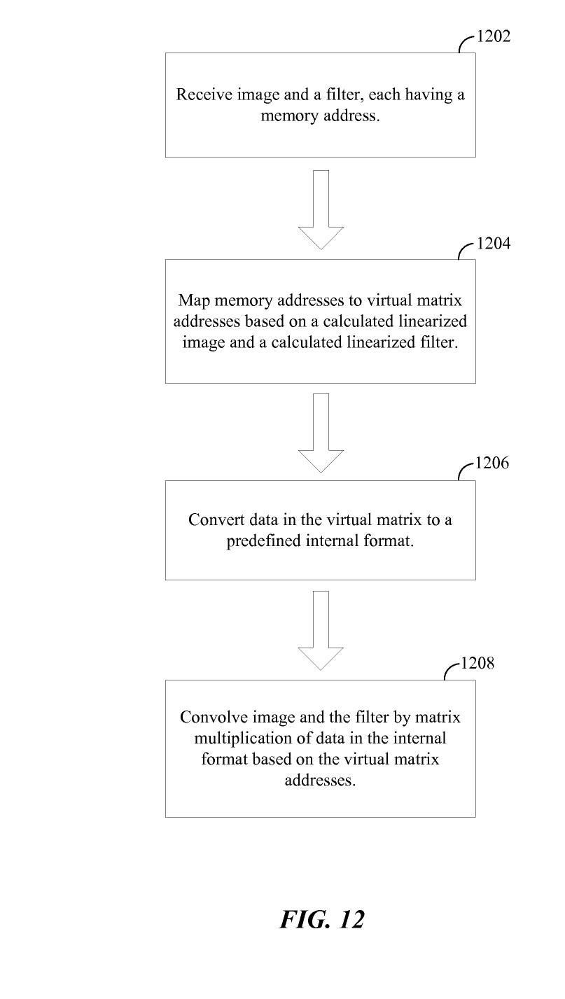

FIG. 12 illustrates a method of address translation of images and filters to virtual matrices to perform a convolution by matrix multiplication. At block 1202, an image and a filter, each having a memory address, are received. At block 1204, the memory addresses are mapped to virtual matrix addresses based on a calculated linearized image and a calculated linearized filter. At block 1206, the virtual matrix addresses are converted to a predefined internal format. At block 1208, the image and the filter are convolved by matrix multiplication of data in the internal format based on the virtual matrix addresses.

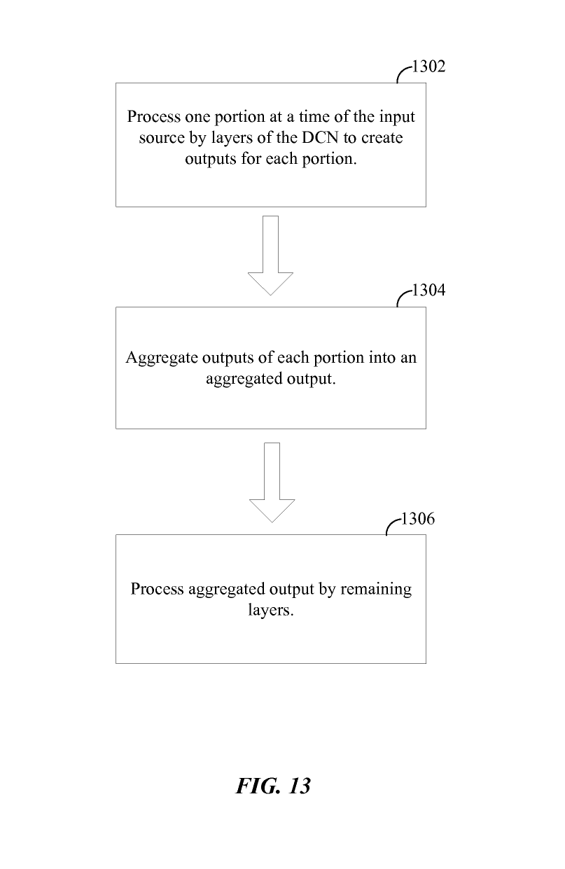

FIG. 13 illustrates a method of processing an input source by a deep convolutional network (DCN). At block 1302, one portion at a time of the input source is processed by layers of the DCN to create outputs for each portion. At block 1304, the outputs of each portion are aggregated into an aggregated output. At block 1306, the aggregated output is processed by remaining layers.

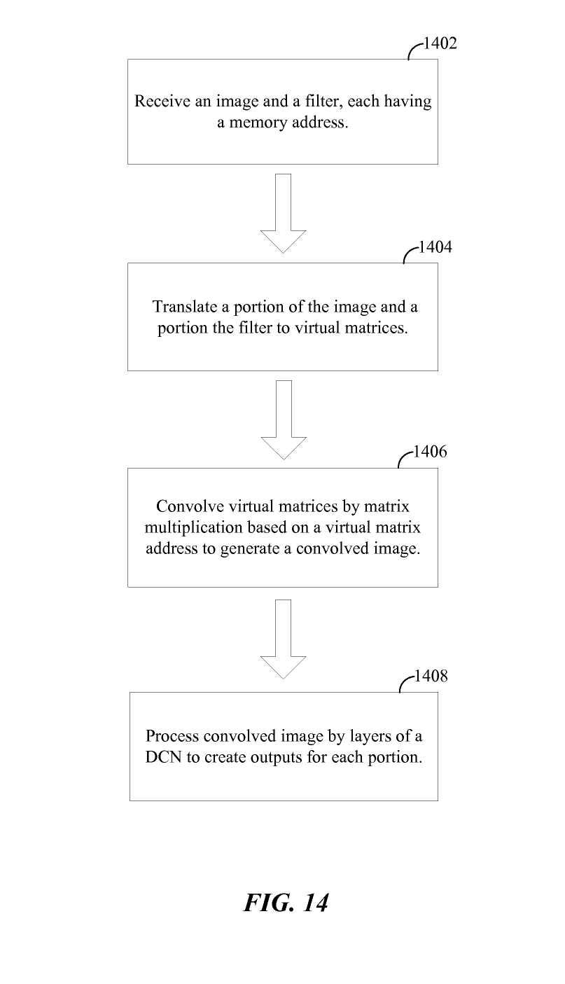

FIG. 14 illustrates a method of processing an input source by a deep convolutional network. At block 1402, an image and a filter, each having a memory address, are received. At block 1404, a portion of the image and a portion of the filter are translated to virtual matrices. At block 1406, the virtual matrices are convolved by matrix multiplication based on a virtual matrix address to generate a convolved image. At block 1408, the convolved image is processed by layers of a DCN to create outputs for each portion.

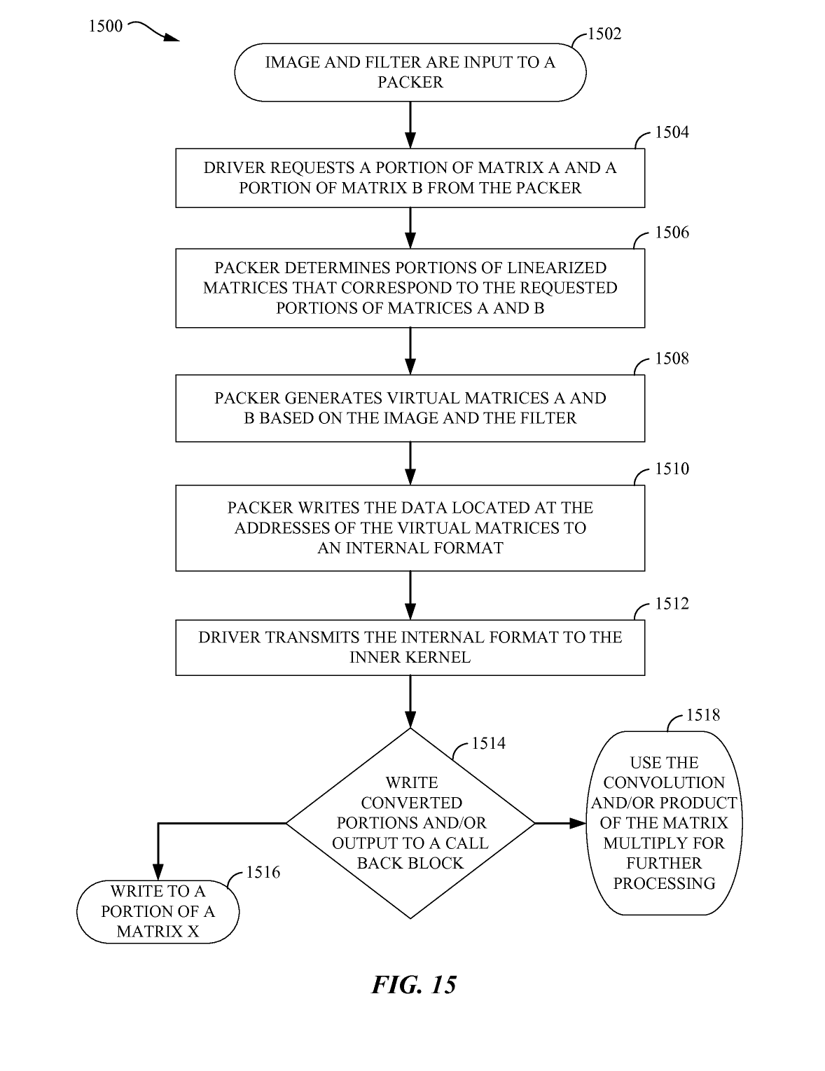

FIG. 15 illustrates an example of a convolution and deep tiling process 1500 according to an aspect of the present disclosure. As shown in FIG. 15, at block 1502, an image and filter are input to a packer. Furthermore, at block 1504, a driver requests a portion of matrix A and a portion of matrix B from the packer. Based on the request, the packer determines portions of linearized matrices that correspond to the requested portions of matrices A and B (block 1506). Still, because the image and the filter have not been linearized to matrices A and B, the packer generates virtual matrices A and B based on the image and the filter (block 1508).

Furthermore, at block 1510, the packer writes the data located at the addresses of the virtual matrices to an internal format, which is passed to the driver. Furthermore, at block 1512, the driver transmits the internal format to the inner kernel. At block 1514, the inner kernel determines whether to write the converted portions generated from the virtual matrices to the portion of matrix C (block 1516) and/or output a product of the matrix multiply to a call back block (block 1518). The call back block may use the convolution and/or product of the matrix multiply for further processing, such as deep tiling.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of address translation of images and filters to virtual matrices to perform a convolution by matrix multiplication, comprising:
receiving an image and a filter, each having a memory address;
mapping the memory addresses to virtual matrix addresses based at least in part on a calculated linearized image and a calculated linearized filter;
converting data in the virtual matrix to a predefined internal format; and
convolving the image by matrix multiplication of the data in the predefined internal format based at least in part on the virtual matrix addresses.

2. The method of claim 1, further comprising declaring as completed a portion of the convolved image in a cache before completing the convolution.

3. The method of claim 2, further comprising:
processing each portion of the convolved image from the cache by a plurality of layers of a DCN to create outputs for each portion;
aggregating the outputs of each portion into an aggregated output; and
processing the aggregated output by a plurality of remaining layers.

4. An apparatus for translating images and filters to virtual matrices to perform a convolution by matrix multiplication, the apparatus comprising:
a memory; and
at least one processor coupled to the memory, the at least one processor configured:
to receive an image and a filter, each having a memory address;
to map the memory addresses to virtual matrix addresses based at least in part on a calculated linearized image and a calculated linearized filter;
to convert data in the virtual matrix to a predefined internal format; and
to convolve the image by matrix multiplication of the data in the predefined internal format based at least in part on the virtual matrix addresses.

5. The apparatus of claim 4, in which the at least one processor is further configured to declare as completed a portion of the convolved image in a cache before completing the convolution.

6. The apparatus of claim 5, in which the at least one processor is further configured:
to process each portion of the convolved image from the cache by a plurality of layers of a DCN to create outputs for each portion;
to aggregate the outputs of each portion into an aggregated output; and
to process the aggregated output by a plurality of remaining layers.

7. A method of processing an input source by a deep convolutional network (DCN), comprising:
processing one portion at a time of the input source by a plurality of layers of the DCN to create outputs for each portion;
aggregating the outputs of each portion into an aggregated output; and
processing the aggregated output by a plurality of remaining layers.

8. The method of claim 7, in which the portions comprise tiles.

9. The method of claim 7, in which the input source comprises an image.

10. The method of claim 7, further comprising storing the output for each portion in a cache memory.

11. The method of claim 7, further comprising selecting a size of each portion to fit within a predetermined memory size so that the output for each portion fits within the predetermined memory size.

12. An apparatus for processing an input source by a deep convolutional network (DCN), the apparatus comprising:
a memory; and
at least one processor coupled to the memory, the at least one processor configured:
to process one portion at a time of the input source by a plurality of layers of the DCN to create outputs for each portion;
to aggregate the outputs of each portion into an aggregated output; and
to process the aggregated output by a plurality of remaining layers.

13. The apparatus of claim 12, in which the portions comprise tiles.

14. The apparatus of claim 12, in which the input source comprises an image.

15. The apparatus of claim 12, further comprising storing the output for each portion in a cache memory.

16. The apparatus of claim 12, in which the at least one processor is further configured to select a size of each portion to fit within a predetermined memory size so that the output for each portion fits within the predetermined memory size.

17. A method of processing an input source by a deep convolutional network (DCN), comprising:
receiving an image and a filter, each having a memory address;
translating a portion of the image and a portion of the filter to virtual matrices;
convolving the virtual matrices by matrix multiplication based at least in part on a virtual matrix address to generate a convolved image; and
processing the convolved image by a plurality of layers of a DCN to create outputs for each portion.

18. The method of claim 17, further comprising:
mapping the memory address to the virtual matrix address based at least in part on a calculated linearized image and a calculated linearized filter;
converting data in the virtual matrix to a predefined internal format; and
convolving the image and the filter by matrix multiplication of the data in the internal format based at least in part on the virtual matrix addresses.

19. The method of claim 17, further comprising:
aggregating the outputs of each portion into an aggregated output; and
processing the aggregated output by a plurality of remaining layers.

20. An apparatus for processing an input source by a deep convolutional network (DCN), the apparatus comprising:
a memory; and
at least one processor coupled to the memory, the at least one processor configured:
to receive an image and a filter, each having a memory address;
to translate a portion of the image and a portion of the filter to virtual matrices;
to convolve the virtual matrices by matrix multiplication based at least in part on a virtual matrix address to generate a convolved image; and
to process the convolved image by a plurality of layers of a DCN to create outputs for each portion.

21. The apparatus of claim 20, in which the at least one processor is further configured:
to map the memory address to the virtual matrix address based at least in part on a calculated linearized image and a calculated linearized filter;
to convert data in the virtual matrix to a predefined internal format; and
to convolve the image and the filter by matrix multiplication of the data in the internal format based at least in part on the virtual matrix addresses.

22. The apparatus of claim 20, in which the at least one processor is further configured:
to aggregate the outputs of each portion into an aggregated output; and
to process the aggregated output by a plurality of remaining layers.
